(19) United States
(12) Patent Application Publication
(10) Pub. No.: US 2012/0082971 A1
(43) Pub. Date: Apr. 5, 2012

(54) PLANTING TOY KIT

(75) Inventor: Charlie KAO, Taipei County (TW)

(73) Assignee: CHARLIE-KAO INDUSTRY CO., LTD., Taipei County (TW)

(21) Appl. No.: 12/894,859

(22) Filed: Sep. 30, 2010

(51) Int. Cl. G09B 23/38

(52) U.S. Cl. 434/276

(57) ABSTRACT

A planting toy kit is composed of hydrophobic fine sand, a phosphate solution and a tree. In use, the hydrophobic fine sand is first made into a mound or place in a proper container. Then a well is made in the sand mound to receive the phosphate solution. The phosphate solution forms a pool marvelously instead of mixing with the hydrophobic fine sand. The tree is afterward planted in the phosphate solution. As the phosphate solution is slowly absorbed by the tree, the phosphate solution gradually crystallizes and gives a snowy appearance to the tree. The planting toy kit breaks the stereotype that sand mixes with water so as to be not only educational for it allows users to experience the pleasure of tree planting and watering, but also amusing for it shows an exterior transformation of the tree.

### BACKGROUND OF THE INVENTION

1. Technical Field

The present invention relates to educational toys, and more particularly, to a planting toy kit, which is composed of hydrophobic fine sand made of silicone oil and quartz sand, a phosphate solution and a tree made of long-fiber absorbent paper. In use, the hydrophobic fine sand as particles in different sizes is mixed in a proper proportion. Then the hydrophobic fine sand is formed into a mound or placed in a container of a proper shape. A well is made in the center of the sand mound, and the phosphate solution is poured into the well. In virtue of the lyophobicity of the hydrophobic fine sand and the surface tension of the liquid itself, the phosphate solution is not absorbed by the hydrophobic fine sand. Instead, the phosphate solution forms a pool in the well. Afterward, the tree is planted in the phosphate solution to slowly absorb the phosphate solution. In addition, a user may use the phosphate solution to water the tree directly. In a proper period of time, the phosphate solution gradually dries up and crystallizes from the tree top. When the phosphate solution finally vapors completely, the tree is fully covered by crystals, like a snowy tree. In such a way, the present invention is not only educational for allowing the users to experience the pleasure of tree planting and watering, but also amusing for showing an instantaneous transformation of the tree.

2. Description of Related Art

The abnormal global weather is crucially caused by the highly developed industries and the excessive exploitation people have made to Earth's resources. Therein, deforestation is particularly responsible. As a result of global climate change, natural calamities increasingly happen in recent years, and cause disaster as well as casualties to organisms and even human beings all over the world. Experts trumpet the conservation of Earth's resources to rehabilitate our planet. To this end, humans shall not only reduce consume Earth's resources, but also actively plant trees. The concept of saving the Earth by planting trees is an important issue that our next generations shall be taught and recognize from their childhood. The best educational way to implant this concept is to practice, that is, to plain real saplings in the soil. However, as restricted by the urban environments, schools, such as kindergartens and elementary schools, in cities, may have difficulty in obtaining enough planting areas for teaching. Hence, simulation pedagogy using teaching aids is an extensively feasible and comparable substitute. There are rare choices of planting toys on the market, and almost all of the presently available planting toys models made of plastic materials. While these existing toys are somehow useful in practicing planting, they are not good verisimilitudes because the touch they give is far from that offered by real saplings and sand. Therefore, improvement in the prior art is desired.

### SUMMARY OF THE INVENTION

In view of the shortcomings of the prior art, the inventor leveraged his years of experience in design and production of toys to actively research and make improvement, and, through the R&D processes of planning, testing and amending, finally created the disclosed planting toy kit that has been well produced and proven effective. The planting toy kit is composed of hydrophobic fine sand, a phosphate solution and a tree made of long-fiber absorbent paper. The planting toy kit provides education through marvelous, interesting planting and watering practice, and allows its users to observe transformation of the tree, thereby combining education and amusement and effectively enhancing learning efficiency.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic drawing showing components of a planting toy kit according to the present invention;

FIG. 2 is a schematic drawing showing a sand mound on a tabletop with a well therein according to the present invention;

FIG. 3 is a schematic drawing showing the well of FIG. 2 filled with a phosphate solution according to the present invention;

FIG. 4 is a schematic drawing showing a tree planted in the phosphate solution of FIG. 3 according to the present invention;

FIG. 5 is a schematic drawing showing the tree of FIG. 4 watered by the phosphate solution according to the present invention;

FIG. 6 is a schematic drawing showing the hydrophobic fine sand received in a container and holding the phosphate solution with the tree planted therein;

FIG. 7 is a schematic view of another container as a multilayer castle for implement of the present invention;

FIG. 8 is a schematic drawing showing the container of FIG. 7 filled in its multiple layers with hydrophobic fine sand of proper thickness;

FIG. 9 is a schematic drawing showing the phosphate solution poured from the topmost layer of the container of FIG. 8 and flowing toward the middle and bottommost layers; and

FIG. 10 is a schematic drawing showing plural trees planted in the phosphate solution filled in the multiple layers of the container of FIG. 9 to form a forest.

### DETAILED DESCRIPTION OF THE INVENTION

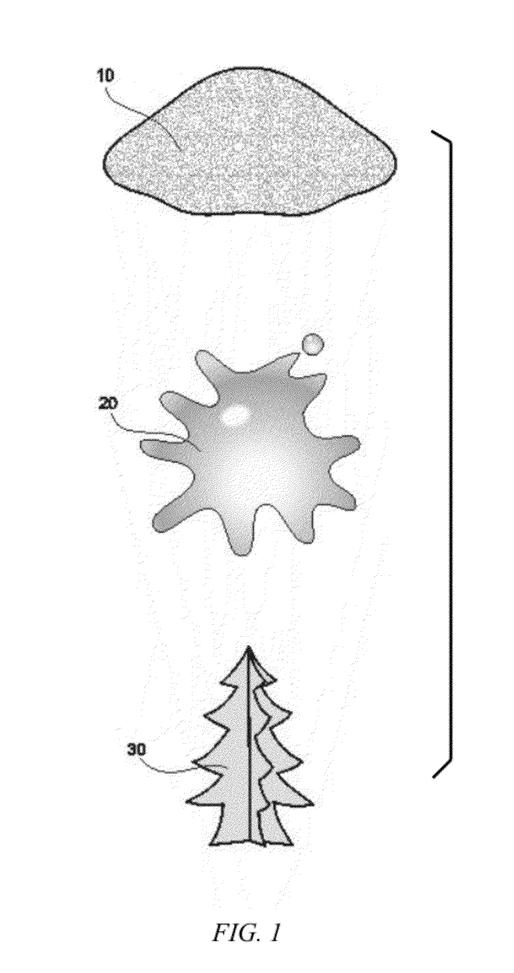

Referring to FIG. 1, a planting toy kit of the present invention is primarily composed of hydrophobic fine sand 10, a phosphate solution 20 and a tree 30. Therein, the hydrophobic fine sand 10 is made by processing silicone oil distally having hydrogen bonds (H₂) and quartz sand having oxygen bonds (O) with consideration of interaction between different sizes of the quartz sand and different temperatures to form sand repulsive to water. The phosphate solution 20 is a liquid made by mixing phosphate crystals of different lengths and water in a proper proportion. The tree 30 is made of long-fiber absorbent paper as a two- or three dimensional tree-like object colored with proper colors.

By using the above components of the planting toy kit of the present invention, a lifelike planting for educational purposes can be realized in several ways to add learning interest. Some particular examples of using the planting toy kit are described blow for illustration.

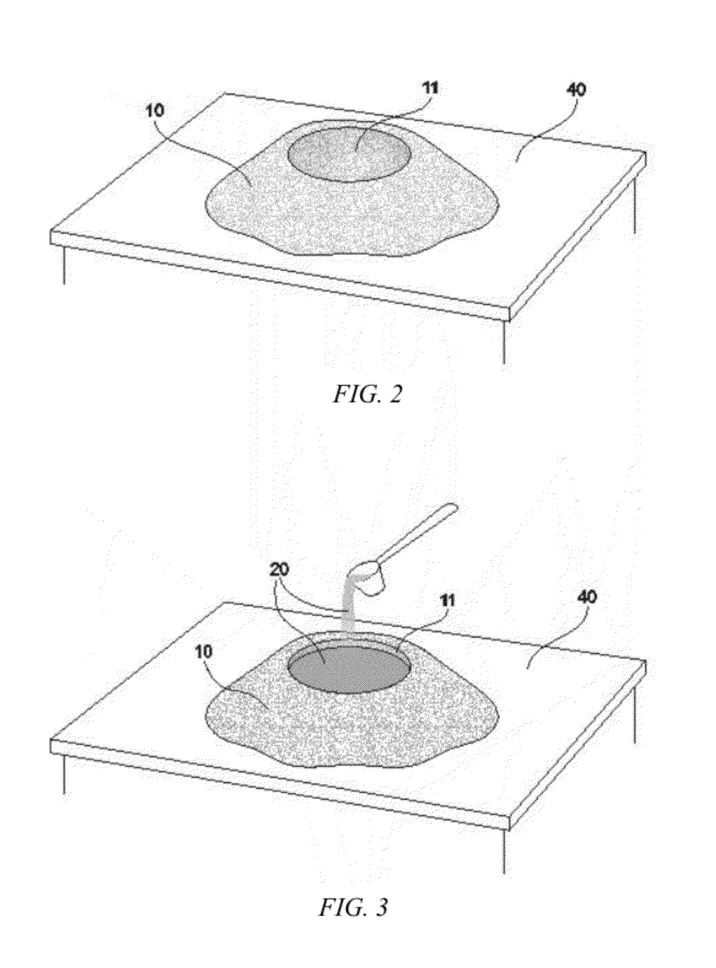

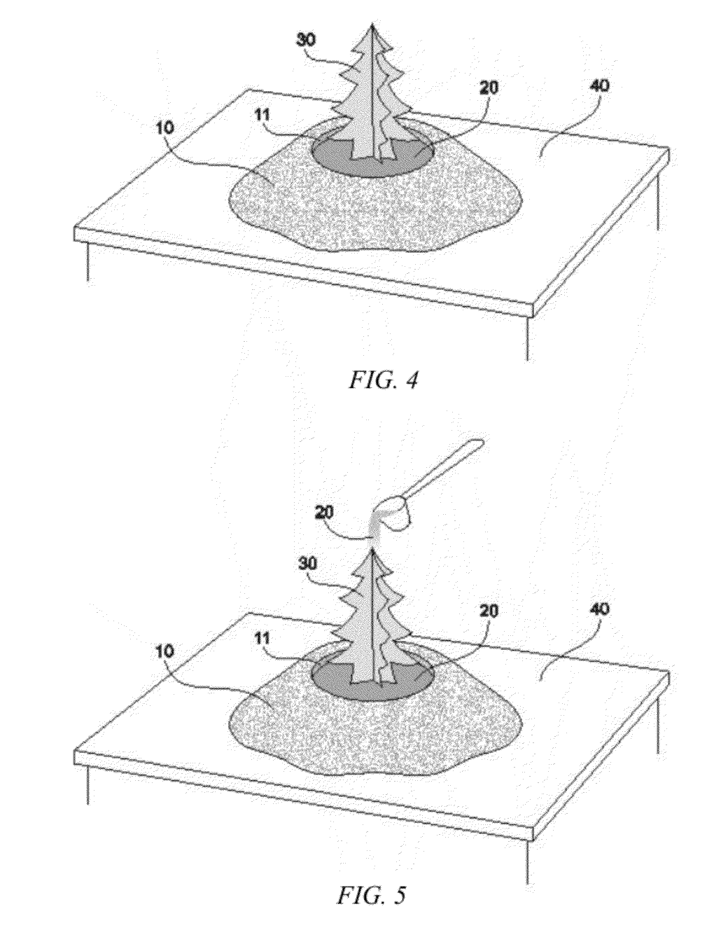

Referring to FIG. 2, the hydrophobic fine sand 10 as particles in different sizes is mixed in such a proportion that intervals between particles are eliminated as many as possible. The properly mixed hydrophobic fine sand 10 is made into a mound on a tabletop 40, and has a well 11 made therein. Then, as shown in FIG. 3, the phosphate solution 20 is poured into the well 11 for filling the latter to a proper level. Since the hydrophobic fine sand 10, as such, is lyophobic, and the phosphate solution 20 has its surface tension, it is marvelous that the phosphate solution 20 is not absorbed by the hydrophobic fine sand 10, thereby breaking the stereotype that sand mixes with water, and thus giving marvelous fun. The phosphate solution 20 forms a poll in the well 11 of the hydrophobic fine sand 10, and the tree 30 can be planted into the phosphate solution 20, as shown in FIG. 4. Because the tree 30 is made of long-fiber absorbent paper, the phosphate solution 20 is absorbed by the tree 30 and gradually evaporates and dries up as time passes. Meanwhile, we cab water the tree 30 from top with the phosphate solution 20, as shown in FIG. 5, so as to simulate irrigating plants. After 2˜3 hours, the top of the tree 30 begins to have crystals. After 12 hours, the phosphate solution 30 fully dries up and crystallizes to make the tree 30 fully covered by the crystals. In the present embodiment, the tree 30 is formed as a Christmas tree, so the crystals make it a snowy Christmas tree, which is beautiful and interesting.

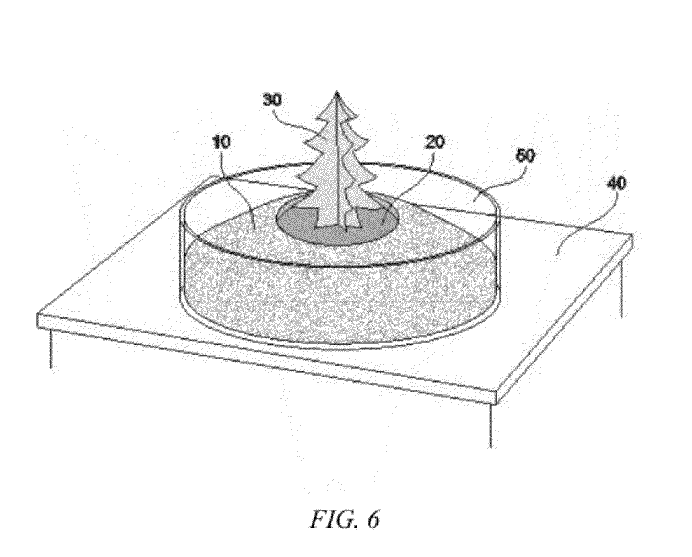

Referring to FIG. 6, the hydrophobic fine sand 10 of the present invention may be placed in a proper container 50 with a well 11 similarly made therein and filled with the phosphate solution 20. Then the tree 30 can be planted in the phosphate solution 20 for educational planting without the concern of collapse of the sand mound.

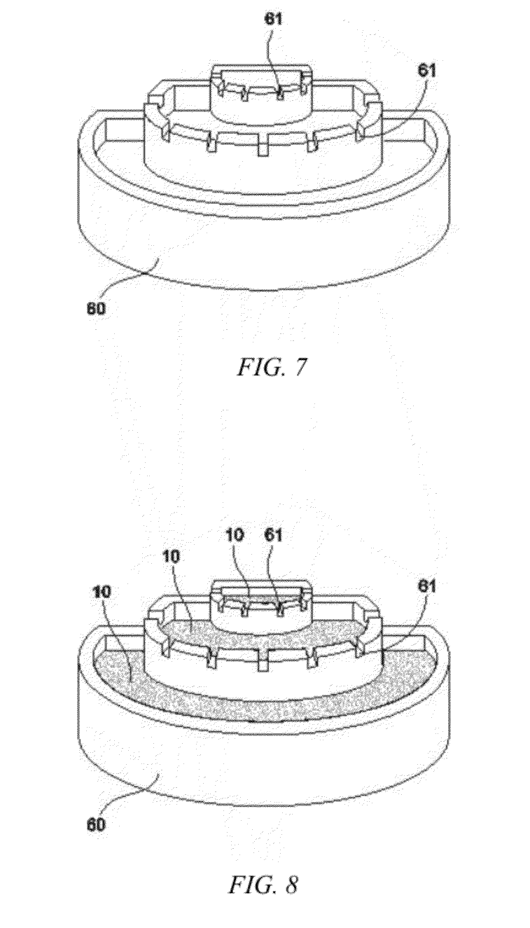

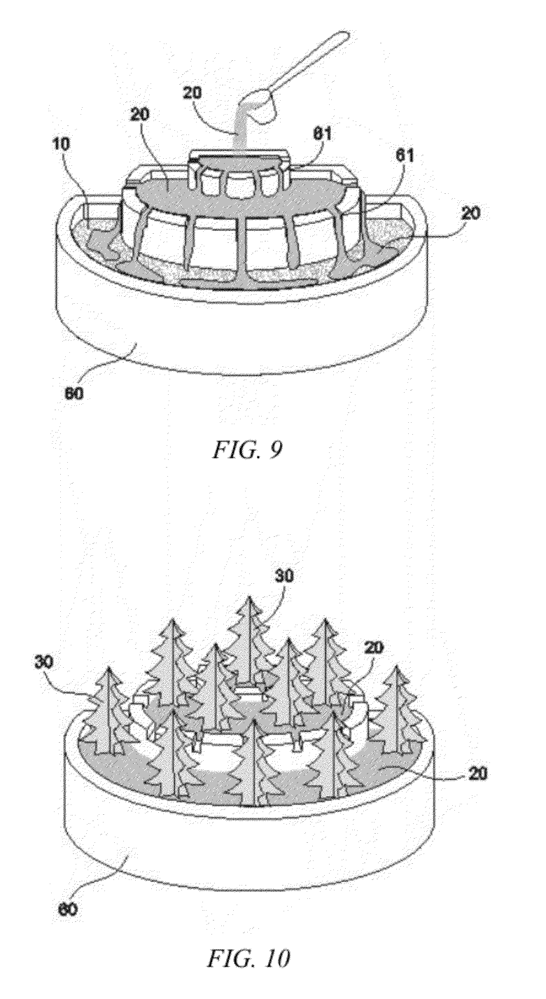

Moreover, the present invention may be implemented in a castle-like container 60 of a larger capacity, as shown in FIG. 7. The castle-like container 60 is multilayer (with three layers in the present embodiment), and the top two layers are peripherally formed with plural crenels 61. We can, as shown in FIG. 8, place the hydrophobic fine sand 10 of a proper thickness in the layers, and then, as depicted by FIG. 9, pour the phosphate solution 20 from the topmost layer so that after the topmost layer is filled, the phosphate solution 20 flows through the peripheral crenels 61 to the middle layer, and after the middle layer is filled, the phosphate solution 20 flows through the peripheral crenels 61 to the bottommost layer, until the three layers are all filled with the phosphate solution 20 of proper level. Afterward, plural said trees 30 may be planted in the three layers of phosphate solution 20, as shown in FIG. 10, to present a magnificent forest landscape. Also, after a proper period for absorption and evaporation, the tree 30 are fully covered by crystals, like a snowy forest, thereby providing fun and artistry.

Through the foregoing description, it is proven that the present invention uses the ingeniously designed component and their individual characteristics, such as hydrophobicity and absorption, allows users to practice with materials that resemble the real planting materials (soil and water) most, so as to not only break the stereotype that sand mixes with water, but also provide novel and marvelous combinations that give users (young learners) real planting experience through the interesting operation and surprise caused by the transformation of the trees (becoming snowy), thereby combining education and amusement. For these reasons, the present invention, as compared with conventional planting toys, has better advancement, amusement and learning efficiency, so the present application is herein made according to law for your examination and grant with patent rights.

It is to be noted that all the arrangements and combinations made from the hydrophobic fine sand, the phosphate solution and the long-fiber-paper tree as disclosed in the present invention shall be within the scope of the present invention.

What is claimed is:

1. A planting toy kit, comprising hydrophobic fine sand, a phosphate solution and at least a tree, wherein the hydrophobic fine sand is sand repulsive to water made by processing silicone oil and quartz sand with consideration of interaction between different sizes of the quartz sand and different temperatures, and the phosphate solution is a liquid made by mixing phosphate crystals of different lengths and water in a proper proportion, while the tree is made of long-fiber absorbent paper as a two-dimensional or three-dimensional object colored with proper colors; in use, the hydrophobic fine sand as particles in different sizes being mixed in a proper proportion and made into a mound or placed in a container of a proper shape, a well being made or formed in the sand, the phosphate solution filling the well to a proper level, and one or more said trees being planted into the phosphate solution, so that by absorption of the tree to the phosphate solution, and by evaporation and crystallization of the phosphate solution, after a proper period of time, the tree is covered by crystals.
